(19) United States
(12) Patent Application Publication
(10) Pub. No.: US 2025/0139694 A1
(43) Pub. Date: May 1, 2025

(54) TREASURE CHEST STASHES

(71) Applicant: Wells Fargo Bank, N.A., San Francisco, CA (US)

(72) Inventors: Nancy Jonathans, Berkeley, CA (US); Purbasha Mazumdar, San Jose, CA (US); Laura Earle Newberg-Hoffman, Granger, IA (US); Pragya Shukla, Cary, NC (US); Zoran Stanisljevic, Mint Hill, NC (US); Anita Sukur, Minneapolis, MN (US); Jennifer Toby Whateley, Fremont, CA (US)

(21) Appl. No.: 18/163,185

(22) Filed: Feb. 1, 2023

(51) Int. Cl. G06Q 40/02; G06Q 30/0207; G06Q 40/10

(52) U.S. Cl. CPC G06Q 40/02; G06Q 30/0239; G06Q 40/10

(57) ABSTRACT

A computing system may be configured to maintain virtual accounts or stashes for designated purchases or goals on top of underlying accounts. The computing system may enable funds to be auto-transferred from other accounts to virtual accounts. The computing systems may also recommend amounts to transfer into a virtual account. For example, a virtual account/stash for taxes may be auto-funded to cover predicted taxes for a small business. Recommendations for new virtual accounts/stashes may be made for future purchases and the like. Vendor offers, such as coupons relevant to the user, may also be provided to users of the virtual accounts based on the user's interactions with the system.

### TECHNICAL FIELD

This disclosure relates to computer networks, and in particular, to interconnecting computer networks for financial transactions.

### BACKGROUND

Small businesses often use a single account for both personal and business matters due to the relatively low account amounts involved, but that can make taxes or accounting difficult. This can be stressful for small business owners since they then need to keep track of the bookkeeping, often without help. Business checking accounts may allow users to better separate business and personal expenses and prepare for taxes, but small businesses are often hesitant to open business checking accounts due to difficulties opening the accounts and the ongoing requirements of such business checking accounts.

### SUMMARY

A combined account management platform may address the needs of small businesses and skilled gig workers. The combined account management platform may enable the small businesses and skilled gig workers to better manage personal and business expenses in a variety of ways by providing a central location for both business and personal banking.

In some examples, the disclosed combined account management platform comprises a computing system configured to enable users to reassign credit card transactions. The transactions of a credit card may be originally assigned to a default account and then later reassigned by the user. For example, the credit card may assign the transaction to a personal account as a default and then transactions that are related to a business may be reassigned to a business account. This reassignment technique enables the user to use the same credit card for both business and personal purchases and, after the purchases are performed, categorize or assign the purchases to the appropriate one of the business account or personal account for payment. In some examples, the reassignments may include reassignments to virtual accounts for designated purchases (referred to herein as “stashes”). The combined account management platform generates data representative of a user interface configured to present the purchases on a display of a user device and receive user input for a particular purchase, including contextual comments and receipt capture viewable by the user and/or the user's business partners. The combined account management platform may restrict access to the user's business partners such that they may view pages for business purchases but not the user's personal purchases.

In some examples, the disclosed combined account management platform comprises a computing system configured to predict cashflow associated with the business account, or across all user accounts, based on transaction information. The combined account management platform may generate data representative of a user interface configured to present predicted cashflow associated with a particular account, which may include predictions for multiple days, on a display of a user device. The user interface may include indicators on a graphic display, such as a calendar or a heatmap, of predicted shortfalls in the cashflow associated with the particular account. The computing system may determine and present recommendations via the user interface of fund sources (e.g., other user accounts) from which the user may select to transfer funds to the particular account in order to cover the predicted shortfalls.

In some examples, the disclosed combined account management platform comprises a computing system configured to maintain virtual accounts or stashes for designated purchases or goals on top of underlying user accounts. The computing system may facilitate automatic transfer or partitioning of funds from other user accounts to the established virtual accounts. The computing system may also generate recommendations on an amount of funds to transfer into a virtual account. For example, the computing system may be configured to auto-fund a virtual account/stash established to cover a predicted amount of quarterly or annual taxes for the user's small business. The computing system may generate recommendations for establishment of new virtual accounts/stashes for future purchases and the like. The computing system may also present vendor offers to the user of a virtual account, such as coupons relevant to the purchase for which the virtual account is established, based on the user's interactions with the computing system and the virtual account.

In one example, this disclosure is directed to a method comprising: generating, by the computing system, recommended allocation rules, the recommended allocation rules indicating recommended allocations of funds from one or more accounts to a virtual account; generating, by the computing system for display on a user device of a user, data representing a user interface including a selection screen for selecting one of the recommended allocation rules; receiving, by the computing system from the user device, a selected allocation rule of the recommended allocation rules; and thereafter, upon an increase of funds in the one of the one or more accounts, automatically moving funds to the virtual account using the selected allocation rule.

In another example, this disclosure is directed to a computing system comprising: one or more interfaces; and one or more processors in communication with the one or more interfaces, the one or more processors configured to: generate recommended allocation rules, the recommended allocation rules indicating recommended allocations of funds from one or more accounts to a virtual account; generate, for display on a user device of a user, data representing a user interface including a selection screen for selecting one of the recommended allocation rules; receive, from the user device, a selected allocation rule of the recommended allocation rules; and thereafter, upon an increase of funds in the one of the one or more accounts, automatically move funds to the virtual account using the selected allocation rule.

In a further example, this disclosure is directed to anon-transitory computer-readable storage medium comprising instructions that, when executed, cause one or more processors to: generate recommended allocation rules, the recommended allocation rules indicating recommended allocations of funds from one or more accounts to a virtual account; generate, for display on a user device of a user, data representing a user interface including a selection screen for selecting one of the recommended allocation rules; receive, from the user device, a selected allocation rule of the recommended allocation rules; and thereafter, upon an increase of funds in the one of the one or more accounts, automatically move funds to the virtual account using the selected allocation rule.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a block diagram illustrating an example network including a combined account management platform, in accordance with one or more aspects of the present disclosure.

FIG. 2 is a block diagram illustrating an example computing system with combined account management platform functionality, in accordance with one or more aspects of the present disclosure.

FIG. 3 is a block diagram illustrating an example user device with a combined account management application, in accordance with one or more aspects of the present disclosure.

FIG. 4 illustrates an interface page for a credit card in a virtual wallet for display on a user device, in accordance with the techniques of this disclosure.

FIGS. 5A-5B illustrate example user interfaces generated by a credit card transaction reassignment application for display on a user device, in accordance with the techniques of this disclosure.

FIGS. 6A-6C illustrate example user interfaces generated by a forecasting application for display on a user device, in accordance with the techniques of this disclosure.

FIGS. 7A-7D illustrate example user interfaces generated by virtual account management application for display on a user device, in accordance with the techniques of this disclosure.

FIG. 8 is a flow diagram illustrating operations performed by an example computing system executing a credit card transaction reassignment application, in accordance with one or more aspects of the present disclosure.

FIG. 9 is a flow diagram illustrating operations performed by an example computing system executing a forecasting application, in accordance with one or more aspects of the present disclosure.

FIG. 10 is a flow diagram illustrating operations performed by an example computing system executing a virtual account management application, in accordance with one or more aspects of the present disclosure.

### DETAILED DESCRIPTION

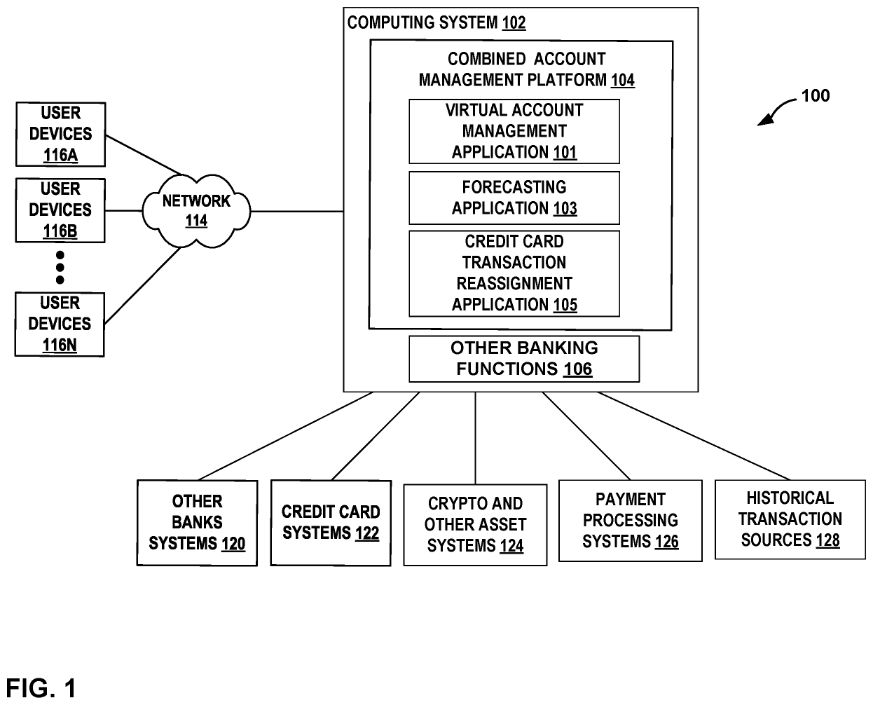

FIG. 1 is a block diagram illustrating enterprise network 100 including computing system 102 with combined account management platform 104, in accordance with one or more aspects of the present disclosure, in accordance with one or more aspects of the present disclosure. Combined account management platform 104 may combine account information for personal and business accounts as well as virtual accounts described below. Enterprise network 100 may be a large-scale enterprise network used or administered by a large organization, such as a financial institution, bank, medical facility, or other type of large organization, which will commonly rely on significant computing resources. For some large organizations, the required computing resources may be provided through multiple data centers deployed within the enterprise network.

As illustrated in FIG. 1, enterprise network 100 may include a computing system 102 implementing a combined account management platform 104. Computing system 102 may be implemented at multiple data centers with multiple computing devices.

Network 114 illustrated in FIG. 1 may include or represent any public or private communications network or other network. One or more client devices, server devices, or other devices may transmit and receive data, commands, control signals, and/or other information across such networks using any suitable communication techniques. In some examples, network 114 may be a separate network as illustrated in FIG. 1, or one or more of such networks may be a subnetwork of another network. In other examples, two or more of such networks may be combined into a single network; further, one or more of such networks may be, or may be part of, the internet. Accordingly, one or more of the devices or systems illustrated in FIG. 1 may be in a remote location relative to one or more other illustrated devices or systems. Network 114 illustrated in FIG. 1 may include one or more network hubs, network switches, network routers, network links, satellite dishes, or any other network equipment. Such devices or components may be operatively inter-coupled, thereby providing for the exchange of information between computers, devices, or other components (e.g., between one or more user devices or systems and one or more server devices or systems).

For transactions performed at a merchant, the user's financial information may be retrieved when credit card accesses a point-of-sale (POS) device for the merchant. The credit card and the POS device may exchange power and data to complete the transaction through either direct contact or some form of short-range wireless communication, e.g., near-field communication (NFC), radio-frequency identification (RFID), Bluetooth®, or the like.

Typically, a credit card transaction goes through a credit card network to a credit card issuer such as a bank or other financial institution. The merchant sends the transaction to the credit card network, which forwards the transaction to the credit card issuer, which reviews the transaction and approves or denies it, then send the decision back to the credit card network that passes the decision back to the merchant.

In the example illustrated in FIG. 1, computing system 102 may be part of the card issuer or interact with the card issuer. Computing system 102 may be a portion of a financial institution, e.g., a bank or a non-bank entity, capable of providing, or interacting with a system providing, payment services in the form of credit cards. In some examples, computing system 102 may comprise one or more computing devices, such as such as desktop computers, laptops, workstations, wireless devices, network-ready appliances, file servers, print servers, or other devices, included in a centralized or distributed system of computing devices for the financial institution. Credit cards issued by the card issuer may be linked to a user's account with the card issuer.

In the case of a traditional credit card, the account may comprise an amount of credit available to the user. In the case of a debit card, the account may comprise a checking or savings account that belongs to the user. For ease of explanation, this disclosure uses the term “credit card” to refer to both a traditional credit card and a debit card.

In accordance with the disclosed techniques, combined account management platform 104 may be used with a single credit card that may serve as both a personal and business card for a user. The credit card may be tied to combined account management platform 104 which may enable users to view both personal and business accounts The combined account may be associated with a virtual account (such as one of those discussed below). The virtual account or stash may be for a specific purpose, such as such as a payday stash, savings stash, health savings account (HAS) stash, taxes stash a stashes for a new purchase such a new computer or car. A platform may be configured to enable the virtual account to be selected as a payment source for the transaction.

The virtual account may be associated with two or more actual accounts, such as a personal and a business account. The credit or debit card may be a virtual credit card associated with the two or more actual accounts. The user device may provide access to the credit or debit card, such as in a virtual wallet application. Alternately or in addition, a separate physical credit or debit card may be used.

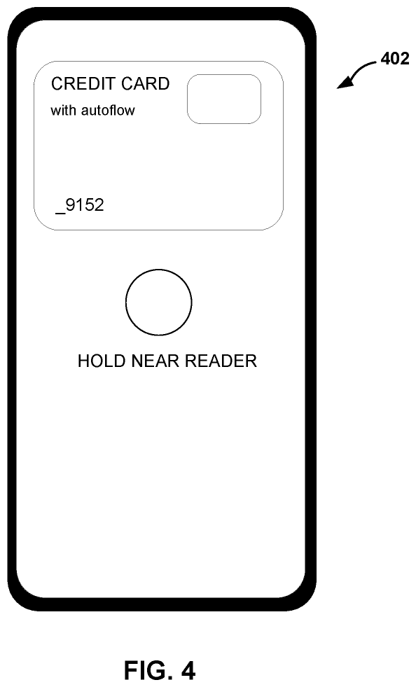

Combined account management platform 104, along with credit card transaction reassignment application 105, forecast application 103, and virtual account management application 101 may produce a number of user interface pages at user devices. Examples of such user interface pages are discussed below with respect to FIGS. 4, 5A-4B, 6A-6C, and 7A-7D. Combined account management platform 104 may produce a user interface that may include multiple tabs including a first tab for the personal account and a second tab for the business account. Having separate tabs for the business and personal accounts may help the user keep track of the separate accounts, navigate easily between these accounts, as well as save display space on a screen of the user device.

During setup a user may bring all accounts into the combined account management platform 104. A user interface of combined account management platform 104 may enable users to identify external and internal accounts credit cards and sources of alternative funds. A user interface of combined account management platform 104 may enable users to identify certain accounts as being business accounts and certain accounts as being personal accounts. This may enable combined account management platform 104 to provide a holistic view of a user's entire financial situation. Combined account management platform 104 may act as a front for underlying accounts.

Free lancers, skilled gig-workers, sole proprietors, small partnerships, and microbusinesses often co-mingle business and personal accounts. Combined account management platform 104 may provide a unified banking platform that helps the user keep the accounts and transactions separate through a tabbed dashboard (one tab is business, the other is personal). Once all accounts are loaded into the dashboard, combined account management platform 104 may provide a holistic view of both business and personal accounts for a user.

Combined personal and business account management platform 104 may enable accounts from multiple banking institutions to be consolidated together. Combined account management platform 104 may use interbank transfers to update account balances at different banking institutions. Combined account management platform 104 may enable the user to import accounts into the dashboard and identify the account as either being a personal account or a business account.

Combined personal and business account management platform 104 may keep track of reward points and other benefits. Combined account management platform 104 may assign reward points associated with personal transactions to the user with rewards points associated with business transactions may split by the owners of the business account (if a joint account). For example, rewards points may be used to pay a bill or cover a late payment.

As shown in FIG. 1, combined account management platform 104 may include credit card transaction reassignment application 105, forecast application 103, and virtual account management application 101 as described below, as well as additional functionality.

Credit card transaction reassignment application 105 may be used to reassign a transaction from one or more accounts. Credit card transaction reassignment application 105 may enable the user to select the payment source for the transaction out of a personal account, a business account, or a linked virtual account, such as a stash, of segregated funds. When a transaction is performed using the credit card, credit card transaction reassignment application 105 may enable the user to assign the transaction as either personal or business for purposes of payment. Credit card transaction reassignment application 105 thus enables the use of a single credit card for personal and business use and may help a user, such as a small businessperson, keep track of their finances.

Credit card transaction reassignment application 105, or other functionality in combined account management platform 104 may receive a first indication of a transaction using a credit or debit card. Credit card transaction reassignment application 105, or other functionality in combined account management platform 104 may generate data representative of a user interface including a second indication of the transaction for display on a user device of the user. Credit card transaction reassignment application 105 may receive, from the user device in response to user interactions with the user interface at the user device, a reassignment request of the transaction to one of a business account or a personal account of the user.

In response to receiving the reassignment request, credit card transaction reassignment application 105 may execute a transfer of the transaction to the one of the business account or the personal account for payment of the transaction.

Credit card transaction reassignment application 105, or other functionality in combined account management platform 104, may initially assign the transaction to a default account, such as the business or personal account. Credit card transaction reassignment application 105, or other functionality in combined account management platform 104, may enable a user to set this default account. For example, credit card transaction reassignment application 105, or other functionality in combined account management platform 104 may enable the user to set the default account, such as to set the default account to the account that user intends the credit card to be primarily used for.

Alternately, credit card transaction reassignment application 105, or other functionality in combined account management platform 104, may automatically determine an initial account to assign a particular transaction. For example, transaction details including a store name may be used to determine the initial account for the transaction. If the user has always in the past assigned transactions from a specific gas station (which may be near a client) to the business account, a new transaction from that gas station may be initially applied to the business account as well. Credit card transaction reassignment application 105, or other functionality in combined account management platform 104, may use machine learning models to determine the initial assignment. Such a machine learning model may be trained using personal and general consumer transaction data. Combined account management platform 104 may enable the user to override or correct any such auto-classification. Even if a default initial account is used, credit card transaction reassignment application 105 may make recommendations for certain transactions as being related to the personal or business account using similar logic.

Combined account management platform 104 may provide a commenting platform configured to receive comments from multiple users that are viewable in a shared user interface on the multiple users' devices. For example, a page for the transaction may allow the users to send messages that are associated with the transaction. If a transaction is marked as a business transaction, combined account management platform 104 may permit the shared users to see and comment on the transaction (e.g., a business partner that also draws from the same account may post a comment, question, upload a receipt, etc. to the specific transaction). However, if a transaction on the card is marked as personal, combined account management platform 104 may restrict the business partner from viewing the transaction. Combined account management platform 104 may also enable access to be delegated to non-account owners, such as accountants.

Combined account management platform 104 may enable a business account user interface to receive a scan of a receipt associated with the transaction and generate an indication of the scanned receipt at the business account user interface that is viewable by the users at their devices. Combined account management platform 104 may enable receipt scans to be uploaded and stored along with the transaction record.

Combined account management platform 104 may associate the first user device of the first user with the combined account of the first user including both the business account and the personal account of the first user. Combined account management platform 104 may register the first user device, authenticate the first user through the first user device, and authorize permissions for the first user through the first user device to access both the business account and the personal account of the first user. Combined account management platform 104 may associate the second user device of the second user with the business account of the first user while blocking access by the second user device to the personal account of the first user.

Combined account management platform 104 may register the second user device, authenticate the second user through the second user device, and authorize permissions for the second user through the second user device to access the business account of the first user but not the personal account of the first user.

The combined account may be hosted at a first financial institution and the one of the business account or the personal account is hosted at a second financial institution, and wherein executing the transfer of the transaction includes initiating an interbank transfer of the transaction from the combined account at the first financial institution to the one of the business account or the personal account at the second financial institution.

Forecast application 103 may use historic data (invoice payments, payroll, bill pay, etc.) across all the account information to forecast account balances. When a balance is projected to be negative, forecast application 103 may automatically generate suggestions to avoid the negative balance. Using historical information, forecast application 103 may use a forecasting tool to help forecast business and personal account balances. Forecast application 103 may receive historical transaction information concerning a user from a source of historical transaction information. The historical transaction information including associated date information for transactions. For example, the dates of bill payments and amounts of bill payments and dates and amounts of income may be part of the historical transaction information.

Forecast application 103 may determine predictions of future cashflow based on the historical transaction information using a machine learning model. The predictions including daily predictions of cashflow for one or more days subsequent to a present day. For example, Forecast application 103 may forecast the date and amounts of projected bill payments and income using the machine learning model. The machine learning model may be trained on personal and general consumer data. For example, a machine learning model trained on general consumer data may be finetuned based on personal transaction information.

Forecast application 103 may generate data representing a user interface of the predicted future cashflow including the daily predictions of cashflow for the one or more days for display on a user device of the user. Forecast application 103 may determine a predicted shortfall for one of the one or more days by comparing incoming and outgoing funds to identify the predicted shortfall. For example, a shortfall may be predicted when a predicted bill for a certain day would put an account balance below zero.

Forecast application 103 may receive from the user device a funds transfer request prompted by the predicted shortfall. The user may transfer funds from another account for example. When a shortfall is predicted, forecast application 103 may offer the user the ability to obtain additional funds, called a “cashboost”, to avoid having a negative balance in the personal or business accounts. Combined account management platform 104 may enable borrowing from another account, delaying payment of a bill, changing bill pay date, taking out a flex loan, cashing in credit card rewards points, etc.

Forecast application 103 may provide a recommendation of a fund source for the predicted shortfall, such as from a virtual account, or stash, which are discussed below or a loan. Combined account management platform 104 may enable the user to borrow from a virtual account. Combined account management platform 104 may enable the transfer of funds from the virtual account through any underlying account. After a withdrawal from the virtual account, combined account management platform 104 may generate data representative of a recommendation to replenish the virtual account for display on the user device.

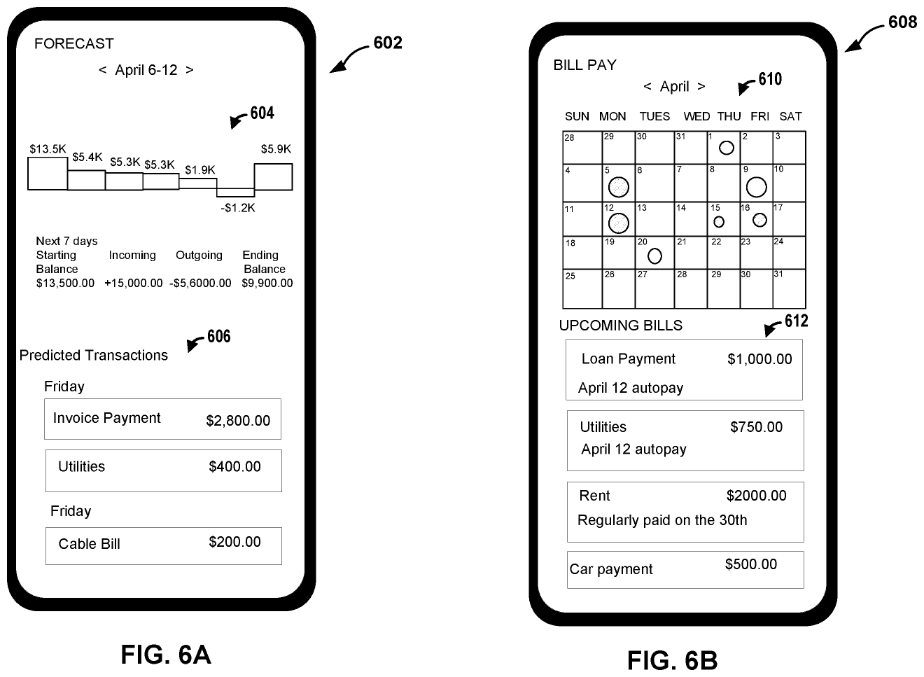

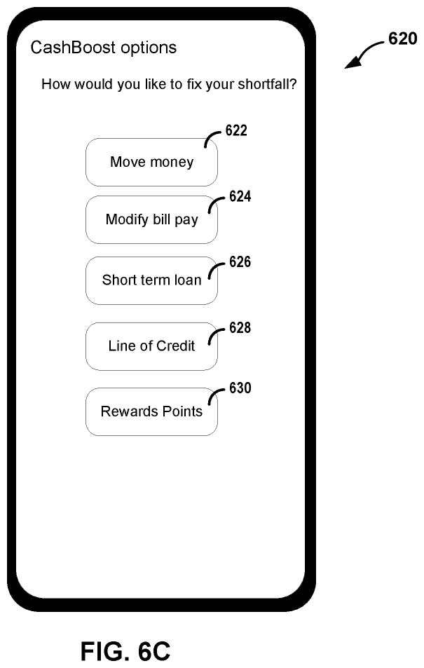

Forecast application 103 may produce the predicted cashflow display as a calendar including daily graphic indications of predicted cashflow, such as that shown in FIGS. 6A and 6B, discussed below. Different sized/colored bars may designate predicted balances or in/out flows of money. Forecast application 103 may produce the predicted cashflow display a heat map with graphic indications of predicted cashflow wherein the graphic indications are sized proportional to the amount of the predicted cashflow, such as that shown in FIG. 6B, discussed below. Virtual account management application 101 may enable virtual accounts, such as stashes, to be created across the personal and business accounts. In one example, a virtual account, such as a stash, is a sub-account where funds are deposited for an identified purpose. Virtual account management application 101 may create and fund stashes automatically. The stashes may be used for designated purpose or as a source for borrowing.

Virtual account management application 101 may create stashes automatically or manually. A stash may be an envelope of segregated funds that are earmarked for certain expenses (e.g., taxes, office equipment, trips, etc.). The stashes may only be spent for the designated purpose or may be reached into when there is a forecasted shortcoming (or if the user just chooses to dissolve the stash).

Virtual account management application 101 may generate recommended allocation rules, the recommended allocation rules indicating recommended allocations of funds from one or more accounts to a virtual account. Virtual account management application 101 may generate for display on a user device of a user data representing a user interface including a selection screen for selecting one of the recommended allocation rules. Virtual account management application 101 may receive from the user device a selected allocation rule of the recommended allocation rules. Thereafter, upon an increase of funds in the one of the one or more accounts, virtual account management application 101 may automatically move funds to the virtual account using the selected allocation rule.

When the virtual account is associated with taxes, virtual account management application 101 may generate at least one of the recommended allocation rules using a tax payment estimate.

When the virtual account is associated with a potential purchase, virtual account management application 101 may produce and send a recommendation to the user device to transfer funds from the virtual account for a transaction related to the potential purchase.

Virtual account management application 101 may transfer credit card transactions to the virtual account. Virtual account management application 101 may receive an indication of the transaction on a credit or debit card associated with a first account, send to a user device, a transfer recommendation to transfer the transaction to the virtual account, and in response to receiving a reassignment request from the user device, transfer the transaction to the virtual account. Virtual account management application 101 may produce the transfer recommendation based on details of the transaction including a store name.

When the virtual account is associated with a potential purchase, virtual account management application 101 may send a discount offer from a supplier when the amount in the virtual account reaches a certain threshold. For example, if the virtual account is to purchase a computer and the amount in the virtual account is close to the amount needed to purchase a computer, a discount offer from a computer retailer may be provided to the user.

Virtual account management application 101 may produce a virtual account creation recommendation based on historical transaction data to create the virtual account. For example, if a user has not purchased a computer in a few years, virtual account management application 101 may suggest that the user set up a virtual account to purchase a computer. In response to instructions from the user device, virtual account management application 101 may then create the virtual account.

Virtual account management application 101 may enable borrowing from the virtual account. Virtual account management application 101 may receive from the user device a borrow request to borrow from the virtual account, reallocate funds from the virtual account based on the borrow request, and thereafter, automatically refill the virtual account. Virtual account management application 101 may enable the user to select a repayment or refilling strategy, such as a certain amount each month or a percentage of funds going into the virtual account.

Virtual account management application 101 may allow the user to associate the virtual account with a goal and once the goal is reached, funds are no longer automatically transferred into the virtual account. For example, a goal of a computer purchase may be an amount sufficient to purchase a computer as selected by the user.

Virtual account management application 101 may automatically create stashes. For example, virtual account management application 101 may determine that a user should save money for taxes as an independent contractor (e.g., a 1099 employee). Virtual account management application 101 may then create a tax stash and fund the stash at the appropriate level based on forecast income and the residence of the user (at the appropriate federal/state tax brackets).

If a transaction appears to be related to a virtual account or stash, virtual account management application 101 may prompt the user for confirmation and pay off the transaction from the stash. (e.g., “$3 k charge at an electronic store—is this the laptop you've been saving for?”).

When borrowing from a virtual account, such as a stash, virtual account management application 101 may automatically generate a stash repayment plan to perform catch up transfers/earmarks to the stash in view of anticipated payroll dates. Virtual account management application 101 may automatically determine the best stash to borrow from (e.g., borrow from the stash to buy a new computer instead of the stash to pay taxes). For example, virtual account management application 101 may prioritize borrowing from a luxury item stash over borrowing from a necessary stash like a tax stash. Virtual account management application 101 may suggest a nudge for a somewhat routine expense that hasn't occurred in a while. For example, if it has been three years since the user purchased a laptop, combined account management platform 104 may suggest a new stash for a laptop.

Virtual account management application 101 may enable users to create any sort of stash, designate personal and business accounts, and designate funding levels. Virtual account management application 101 may be partnered with merchants to offer “stretch” money when a stash is full or almost full. For example, if the purchase is for a laptop, an electronics retailer may advertise that they will give you an extra 5% to spend on a laptop if you spend it at that store. The discount may be automatically applied if the purchase occurs with the credit card associated with the discount. Virtual account management application 101 may provide such advertisements such as through a dashboard view.

Virtual account management application 101 may automatically contribute to stashes when funds come in to a personal or business account. For example, virtual account management application 101 may apply auto-funding for all deposit transactions, only invoices, etc. Virtual account management application 101 may apply a percentage or fixed amount to a stash. Virtual account management application 101 may apply funding in increments (e.g., every $50 of income, put $2 into Stash X). Combined account management platform 104 may prompt such an auto flow to a stash. (“hey—you just received $50 for driving Uber, do you want to designate $10 to the tax stash?”).

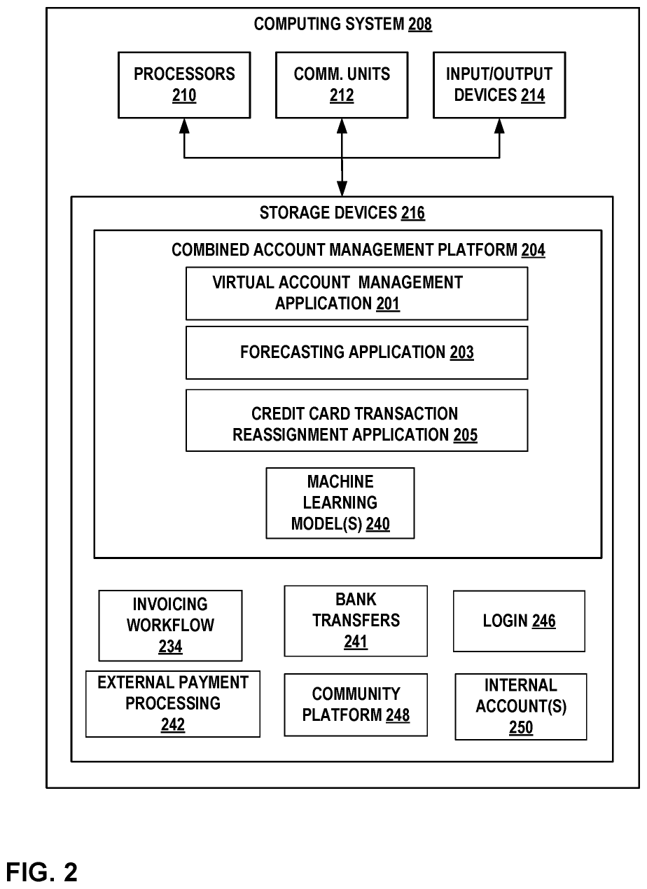

As discussed below with respect to FIG. 2, computing system 102 may include other banking functions 106 such as bank transfer functionality login application, external payments functionality, internal account functionality, and community platform.

Computing system 102 may interface with external computing systems. Computing system 102 may interface with other bank systems 120 to do interbank transfers and account checks. Other bank systems 120 may be a card issuer as discussed above.

Computing system 102 may also interface with credit card systems 122, such as a credit card network, to set up the credit card and to transfer credit card transaction information. When the computing system 102 acts as a card issuer, credit card systems 122 may pass card transaction information to computing system 102. Credit card systems 122 may pass information to computing system 102 as permitted by card holders. Computing system 102 may also interface with payment processing system 126 to do payment processing for transactions.

Computing system 102 may also interface with crypto and other asset systems 124 so that the personal and business accounts may be associated with alternative assets such as crypto. Information concerning these alternative assets may be displayed to user devices 116 using combined account management platform 104.

Computing system 102 may also interface with historical transaction sources 128 to obtain data to do forecasting and calendaring. Information concerning a user's finances may be used to determine cashflow. For example, a user may pay a certain bill or receive a paycheck at a certain day of every month.

Computing system 102 with combined account management platform 104, along with credit card transaction reassignment application 105, forecast application 103, and virtual account management application 101, have a number of technical advantages and practical advantages over prior systems. Combined account management platform 104 may provide account access across different bank and institutions in a single user interface. This saves time and makes it easier for a user to get a grasp on their finances which is especially an issue for small business owners. A single user interface is easier to upgrade, store and use at the user device. Credit card transaction reassignment application 105 makes it easy for a user to use a single credit card for both personal and business use. Rather than using two cards or requiring the user to keep personal records of which purchase should be assigned to personal or business finances for record keeping and accounting at the end of the month, credit card transaction reassignment application 105 enables users to easily reassign assign transactions between a business and personal account. Forecast application 103 enables users to have a better understanding of their finances and enables them to make financial decisions before a potential issue occurs. Virtual account management application 101 may enable users to associate underlying accounts with specific purposes and this helps users keep track of their finances and plan for life events such as taxes. Combined account management platform 104, along with credit card transaction reassignment application 105, forecast application 103, and virtual account management application 101 may use continual learning by machine learning mode models to improve recommendations for virtual accounts, forecasted shortfalls and offers as well as improve predictions for predicted account balances and generally improving the user experience.

FIG. 2 is a block diagram illustrating an example computing system with combined account management platform functionality, in accordance with one or more aspects of the present disclosure. Computing system 208 may generally correspond to computing system 102 of FIG. 1. Accordingly, modules of combined account management platform 204 may perform some or all of the same functions described as being performed by combined account management platform 104 from FIG. 1.

Computing system 208 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, computing system 208 may comprise a server within a data center, cloud computing system, server farm, and/or server cluster (or portion thereof) that provides services to client devices and other devices or systems. For example, computing system 208 may host or provide access to services provided by one or more applications running on computing system 208.

Although computing system 208 of FIG. 2 is illustrated as a stand-alone device, in other examples computing system 208 may be implemented in any of a wide variety of ways, and may be implemented using multiple devices and/or systems. In some examples, computing system 208 may be, or may be part of, any component, device, or system that includes a processor or other suitable computing environment for processing information or executing software instructions and that operates in accordance with one or more aspects of the present disclosure. In some examples, computing system 208 may be fully implemented as hardware in one or more devices or logic elements.

In the example of FIG. 2, computing system 208 may include one or more processors 210, one or more communication units 212, one or more input/output devices 214, and one or more storage devices 216. One or more of the devices, modules, storage areas, or other components of computing system 208 may be interconnected to enable inter-component communications (physically, communicatively, and/or operatively). In some examples, such connectivity may be provided by through communication channels, a system bus, a network connection, an inter-process communication data structure, or any other method for communicating data. A power source (not shown) may provide power to one or more components of computing system 208. In some examples, the power source may receive power from the primary alternative current (AC) power supply in a commercial building or data center, where some or all of an enterprise network may reside. In other examples, the power source may be or may include a battery.

One or more processors 210 of computing system 208 may implement functionality and/or execute instructions associated with computing system 208 associated with one or more modules illustrated herein and/or described below. One or more processors 210 may be, may be part of, and/or may include processing circuitry that performs operations in accordance with one or more aspects of the present disclosure. Examples of processors 210 include microprocessors, application processors, display controllers, auxiliary processors, one or more sensor hubs, and any other hardware configured to function as a processor, a processing unit, or a processing device. Computing system 208 may use one or more processors 210 to perform operations in accordance with one or more aspects of the present disclosure using software, hardware, firmware, or a mixture of hardware, software, and firmware residing in and/or executing at computing system 208.

One or more communication units 212 of computing system 208 may communicate with devices external to computing system 208 by transmitting and/or receiving data, and may operate, in some respects, as both an input device and an output device. In some examples, communication units 212 may communicate with other devices over a network. In other examples, communication units 212 may send and/or receive radio signals on a radio network such as a cellular radio network. In other examples, communication units 212 of computing system 208 may transmit and/or receive satellite signals on a satellite network such as a Global Positioning System (GPS) network. Examples of communication units 212 include a network interface card (e.g., such as an Ethernet card), an optical transceiver, a radio frequency transceiver, a GPS receiver, or any other type of device that can send and/or receive information. Other examples of communication units 212 may include devices capable of communicating over Bluetooth®, GPS, NFC, ZigBee, and cellular networks (e.g., 3G, 4G, 5G), and Wi-Fi® radios found in mobile devices as well as Universal Serial Bus (USB) controllers and the like. Such communications may adhere to, implement, or abide by appropriate protocols, including Transmission Control Protocol/Internet Protocol (TCP/IP), Ethernet, Bluetooth, NFC, or other technologies or protocols.

One or more input/output devices 214 may represent any input or output devices of computing system 208 not otherwise separately described herein. One or more input/output devices 214 may generate, receive, and/or process input from any type of device capable of detecting input from a human or machine. One or more input/output devices 214 may generate, present, and/or process output through any type of device capable of producing output.

One or more storage devices 216 within computing system 208 may store information for processing during operation of computing system 208. Storage devices 216 may store program instructions and/or data associated with one or more of the modules described in accordance with one or more aspects of this disclosure. One or more processors 210 and one or more storage devices 216 may provide an operating environment or platform for such modules, which may be implemented as software, but may in some examples include any combination of hardware, firmware, and software. One or more processors 210 may execute instructions and one or more storage devices 216 may store instructions and/or data of one or more modules. The combination of processors 210 and storage devices 216 may retrieve, store, and/or execute the instructions and/or data of one or more applications, modules, or software. Processors 210 and/or storage devices 216 may also be operably coupled to one or more other software and/or hardware components, including, but not limited to, one or more of the components of computing system 208 and/or one or more devices or systems illustrated as being connected to computing system 208.

In some examples, one or more storage devices 216 are temporary memories, meaning that a primary purpose of the one or more storage devices is not long-term storage. Storage devices 216 of computing system 208 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art. Storage devices 216, in some examples, also include one or more computer-readable storage media. Storage devices 216 may be configured to store larger amounts of information than volatile memory. Storage devices 216 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories.

In accordance with the disclosed techniques, storage devices 216 may store combined account management platform 204 and associated modules. The modules of combined account management platform 204 may include virtual account management application 201, forecast application 203, and credit card transaction reassignment application 205 and machine learning models 240.

Storage devices 216 may include additional functionality such as bank transfers module 241, external payment processing module 242, login module 246, invoicing workflow module 234, community platform module 248 and internal accounts module 250. These modules are shown as being outside of combined account management platform 204 but such functionality may alternately be integrated with combined account management platform 204.

Combined account management platform 204 may be used to connect to and display internal and external accounts and produce displays associated with these accounts. For example, business and personal accounts may be displayed to users at a single location. External accounts may be accessed and then details provided by the computing system 208.

Forecast application 203 may be used to make forecasts of a user's cash flow. For example, trends in inputs and outputs of a user's account may be tracked and predictions of accounts for specific days may be made. For example, if a utility bill is always paid or due on the 15^{th} of the month and the bill for winter months averages about $750, forecast application 203 may estimate the amount and due date of the utility bill using historical information. Similarly, forecast application 203 may also estimate inflows such as average income or repeated payments may also be estimated.

Forecast application 203 may use historical transaction information concerning a user from a source of historical transaction information, such as historical transaction sources 128 of FIG. 1. The source of historical transaction information may be a historical transaction repository or any another source. The historical transaction information may include associated date information for transactions. Forecast application 203 may use dates of bill payments and income received to determine patterns in the transactions.

Forecast application 203 may produce predictions of cashflow based on the historical transaction information using a machine learning model 240, the predictions including daily predictions for multiple days. Machine learning model 240 may be trained using a number of users historic income and outflow data. After training, machine learning model 240 may then be feed the current users inflows and outflow data and predict cashflow and shortfalls for users and their accounts. The trained machine learning model may also be finetuned or modified with the users data.

Forecast application 203 may produce calendars and heat maps showing the predicted cash flows as described with respect to FIGS. 6A-6C described below. Forecast application 203 may generate data representing a user interface to display the predicted cashflow including the including daily predictions for multiple days. Forecast application 203 may provide to the user device the data to produce a predicted cashflow display of the predicted cashflow at a user interface of a user device of a user. The predicted cashflow display including the daily predictions for multiple days.

Forecast application 203 may create data for a user interface display with size and direction of predicted fund flows shown graphically. For example, a bar chart or graph of predicted account balance for specific days may be created and displayed may be displayed. A calendar may also be used showing predicted fund inflows and outflows graphically. For example, dots of different colors and sizes may be used to show fund inflows and outflows as a type of heatmap.

Combined personal and business account management platform 204 may receive from the user device a funds transfer request prompted by the predicted cashflow display. For example, a shortfall may be corrected by a user using user interface page 620 of FIG. 6C discussed below.

Virtual account management application 201 may maintain the virtual accounts or stashes. Virtual account management application 201 may effectively partition underlying accounts into different virtual accounts or stashes. Funds in a stash may be dedicated to certain projects, such as taxes or a new computer. For example, virtual account management application 201 may partition a $5000 account into a $1000 computer stash, a $2000 tax stash and a $3000 savings stash. Virtual account management application 201 may keep track of the management of the stashes based on the rules configured by the user. For example, a stash may be autoflow enabled such that a certain percentage of funds entering the main account is automatically put into the stash. Virtual account management application 201 may also enable the user to manually transfer funds into a stash.

Virtual account management application 201 may make recommendations to users concerning offers and setting up stashes. Virtual account management application 201 may use business logic and/or machine learning models 240 as discussed below. The relevance of the recommendations are enhanced by the access to transaction details, and business and private accounts (including those from different institutions) available to the combined account management platform 204.

Virtual account management application 201 may be used to keep track of goals for a user. Goals may include associated stashes managed by virtual account management application 201. Virtual account management application 201 may make recommendations of goals and make offers concerning these goals. For example, virtual account management application 201 may suggest a new computer goal if it has been a while since the user purchased a computer and provide vendor offers once a computer stash has reached a certain amount.

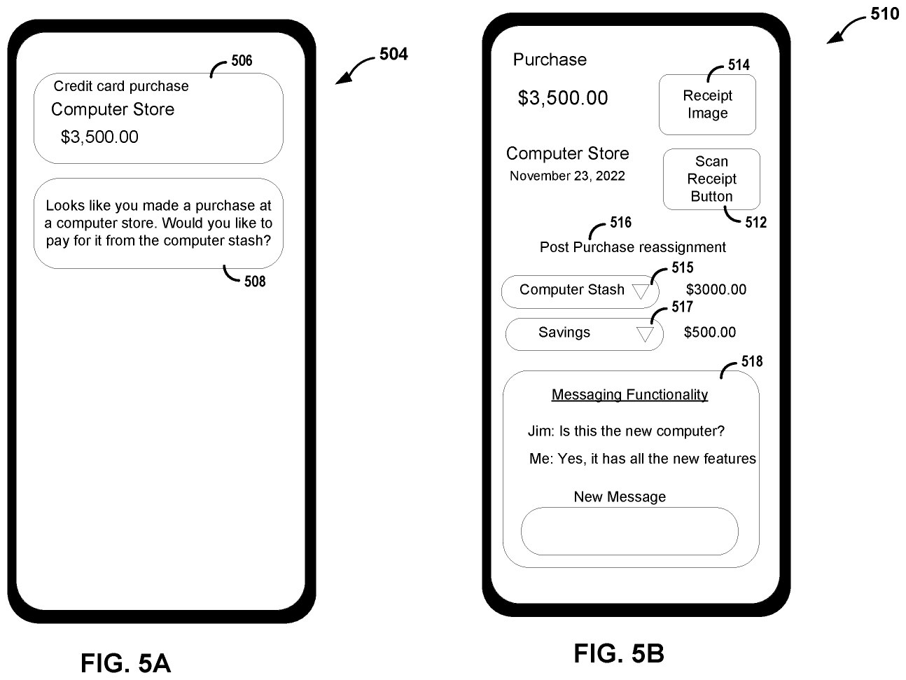

Credit card transaction reassignment application 205 may be used to reassign a transaction from one or more accounts. For example, credit card transaction reassignment application 205 may enable the user to select a payment source for the transaction. For example, Credit card transaction reassignment application 205 may reassign a transaction from an initial account (such as a personal account) to a reassigned account (such as a business account). Credit card transaction reassignment application 205 thus enables the use of a single credit card for both personal and business accounts. FIGS. 5A-5B discussed below shows an example display at a user device of credit card information for a card that enables for assignment of a transaction between a personal and business accounts.

Credit card transaction reassignment application 205 may receive receipt images from user devices and associate them with a user interface page for a transaction. The receipt images may be photos, pdfs or other image files. The receipt information also enables combined account management platform 204 to provide improved services to the user because of improved access to the user's finances.

Credit card transaction reassignment application 205 may send messages concerning a transaction that may be associated with a user interface page for a transaction. FIG. 5B discussed below shows an example display at a user device for a transaction with messaging functionality. Such messages may be transferred between two different users at two different user devices. Credit card transaction reassignment application 205 may store messages and provide them to the appropriate users and user interface pages.

Machine learning models 240 may be used with the modules of FIG. 2. For example, machine learning models 240 may determine forecasts of cashflow to produce the calendaring as well as to produce recommendations and offers to a user. The training process may implement one or more training data sets to create the models. After the training, the created models may be capable of determining an output data set based on an input data set. A computing system may train the machine learning models 240 based on a set of labeled training data related to a plurality of user communications in one or more memories or storage systems within the organization network.

Machine learning models 240 may include a function (e.g., a machine learning algorithm) configured to be executed by processors 210. The function may include nodes, layers, and connections, and the function may be represented by equations having a plurality of variables and a plurality of coefficients.

Machine learning algorithms, such as the function of machine learning models 240, may be trained using a training process to create data-specific models, such as machine learning models 240 based on training data. After the training process, the created models may be capable of determining an output data set based on an input data set. The training process may implement a set of training data to create the model. A training unit may periodically (e.g., monthly, bi-monthly, yearly, or the like) re-train machine learning models 240 based on an updated set of training data.

Invoicing workflow module 234 may be used to create invoices for small businesses which may be sent to clients. Invoicing workflow module 234 may receive information such as client address and amount to bill. Invoicing workflow module 234 may generate an invoice and send it to a client using email functionality. Invoicing workflow module 234 may then keep track of incoming funds from the client and associate them with the invoices.

Bank transfers module 241 may be used to make bank transfers with external banking systems, such as in a reassignment between personal and business account. These may include SWIFT system and other electronic funds transfers (EFT.). For example, if a certain amount is to be applied to a transaction from an external account, bank transfers module 241 may initiate and execute the transfer.

Community platform module 248 may be used to do community building such as supporting newsletters and other information for small businesses. Community platform module 248 may give users access to forums and message boards so that users may access people who may provide advice, such as advice on how to run a small business.

External payment processing module 242 may be used to interface with other payment processing systems. Login module 246 may be used to control logins to the combined account management platform 204. Internal accounts module 250 may be used to control or interact with internal account systems for the institution of the computing system 208. Modules illustrated in FIG. 2 (e.g., combined account management platform 204, virtual account management application 201, forecast application 203, credit card transaction reassignment application 205, machine learning models 240, bank transfers module 241, external payment processing module 242, login module 246, invoicing workflow module 234, community platform module 248 and internal accounts module 250) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

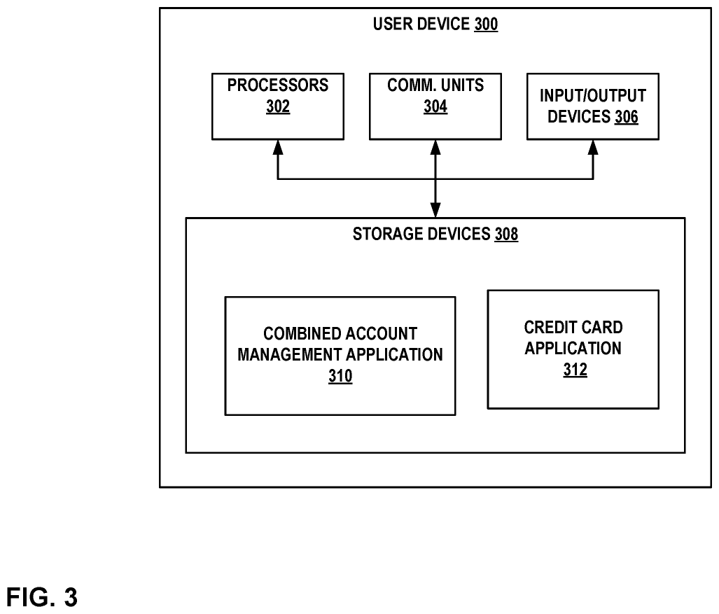

FIG. 3 is a block diagram illustrating an example user device 300 with a combined account management application, in accordance with one or more aspects of the present disclosure. User device 300 may generally correspond to user devices 116A-116N of FIG. 1. Accordingly, user device 300 may perform some or all of the same functions described in connection with FIG. 1 as being performed by user devices 116A-116N.

User device 300 may be implemented as any suitable computing device such as laptop or desktop computers, tablet computers, so-called “smart” phones, “smart” pads, “smart” watches, or other personal digital appliances equipped for wired or wireless communication, that may be capable of performing operations and/or functions described in accordance with one or more aspects of the present disclosure.

Although user device 300 of FIG. 3 is illustrated as a stand-alone device, in other examples user device 300 may be implemented in any of a wide variety of ways, and may be implemented using multiple devices and/or systems. In some examples, user device 300 may be, or may be part of, any component, device, or system that includes a processor or other suitable computing environment for processing information or executing software instructions and that operates in accordance with one or more aspects of the present disclosure. In some examples, user device 300 may be fully implemented as hardware in one or more devices or logic elements.

In the example of FIG. 3, user device 300 may include one or more processors 302, one or more communication units 304, one or more input/output devices 306, and one or more storage devices 308. Storage devices 308 may include combined personal and small business application 310. One or more of the devices, modules, storage areas, or other components of user device 300 may be interconnected to enable inter-component communications (physically, communicatively, and/or operatively). In some examples, such connectivity may be provided by through communication channels, a system bus, a network connection, an inter-process communication data structure, or any other method for communicating data. A power source (not shown) may provide power to one or more components of user device 300. In some examples, the power source may receive power from the primary alternative current (AC) power supply in a commercial building or data center, where some or all of an enterprise network may reside. In other examples, the power source may be or may include a battery.

One or more processors 302 of user device 300 may implement functionality and/or execute instructions associated with user device 300 associated with one or more modules illustrated herein and/or described below. One or more processors 302 may be, may be part of, and/or may include processing circuitry that performs operations in accordance with one or more aspects of the present disclosure. Examples of processors 302 include microprocessors, application processors, display controllers, auxiliary processors, one or more sensor hubs, and any other hardware configured to function as a processor, a processing unit, or a processing device. User device 300 may use one or more processors 302 to perform operations in accordance with one or more aspects of the present disclosure using software, hardware, firmware, or a mixture of hardware, software, and firmware residing in and/or executing at user device 300.

One or more communication units 304 of user device 300 may communicate with devices external to user device 300 by transmitting and/or receiving data, and may operate, in some respects, as both an input device and an output device. In some examples, communication units 304 may communicate with other devices over a network. In other examples, communication units 304 may send and/or receive radio signals on a radio network such as a cellular radio network. In other examples, communication units 304 of user device 300 may transmit and/or receive satellite signals on a satellite network such as a GPS network. Examples of communication units 304 include a network interface card (e.g., such as an Ethernet card), an optical transceiver, a radio frequency transceiver, a GPS receiver, or any other type of device that can send and/or receive information. Other examples of communication units 304 may include devices capable of communicating over Bluetooth®, GPS, NFC, ZigBee, and cellular networks (e.g., 3G, 4G, 5G), and Wi-Fi® radios found in mobile devices as well as USB controllers and the like. Such communications may adhere to, implement, or abide by appropriate protocols, including TCP/IP, Ethernet, Bluetooth, NFC, or other technologies or protocols.

One or more input/output devices 306 may represent any input or output devices of user device 300 not otherwise separately described herein. One or more input/output devices 306 may generate, receive, and/or process input from any type of device capable of detecting input from a human or machine. One or more input/output devices 306 may generate, present, and/or process output through any type of device capable of producing output.

One or more storage devices 308 within user device 300 may store information for processing during operation of user device 300. Storage devices 308 may store program instructions and/or data associated with one or more of the modules described in accordance with one or more aspects of this disclosure. One or more processors 302 and one or more storage devices 308 may provide an operating environment or platform for such modules, which may be implemented as software, but may in some examples include any combination of hardware, firmware, and software. One or more processors 302 may execute instructions and one or more storage devices 308 may store instructions and/or data of one or more modules. The combination of processors 302 and storage devices 308 may retrieve, store, and/or execute the instructions and/or data of one or more applications, modules, or software. Processors 302 and/or storage devices 308 may also be operably coupled to one or more other software and/or hardware components, including, but not limited to, one or more of the components of user device 300 and/or one or more devices or systems illustrated as being connected to user device 300.

In some examples, one or more storage devices 308 are temporary memories, meaning that a primary purpose of the one or more storage devices is not long-term storage. Storage devices 308 of user device 300 may be configured for short-term storage of information as volatile memory and therefore not retain stored contents if deactivated. Examples of volatile memories include RAM, DRAM, SRAM, and other forms of volatile memories known in the art. Storage devices 308, in some examples, also include one or more computer-readable storage media. Storage devices 308 may be configured to store larger amounts of information than volatile memory. Storage devices 308 may further be configured for long-term storage of information as non-volatile memory space and retain information after activate/off cycles. Examples of non-volatile memories include magnetic hard disks, optical discs, floppy disks, Flash memories, or forms of EPROM or EEPROM memories. According to the disclosed techniques, combined account management application 310 may provide the user with access to the cloud- or server-based platform and presents user interfaces (as directed by the platform) with which the user may interact to receive data from and enter data for use by the platform. Examples of user interfaces provided by user device 300 and combined personal and small business management application 310 are shown in FIGS. 4, 5A-4B, 6A-6C, and 7A-7D described below. Combined account management application 310 may be an app or web browser to display pages or other displays implementing functionality discussed in this disclosure.

Credit card application 312, such as a virtual or mobile wallet, may have functionality that enables user device 300 to provide credit card information to point of sale devices using communication units 304. Credit card application 312 may be a standardized application that is supported by the operating system of user device 300. Combined account management platform 204 may interface with credit card application 312 to receive credit card transaction information from the user device 300 as shown in FIG. 4 discussed below.

Applications and modules illustrated in FIG. 3 and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

FIGS. 4, 5A-5B, 6A-6C, and 7A-7D illustrate user interface pages. Combined account management platform 204 of FIG. 2 and/or combined account management application 310 may generate such user interface pages or data for such user interface pages.

FIG. 4 illustrates an interface page 402 for a credit card in a virtual wallet for display on a user device 300, in accordance with the techniques of this disclosure. The user device 300 of FIG. 3 may be used as a credit card using a pay app of the phone. User device 300 may interact with a reader when user device 300 is put in proximity to a reader. The credit card at user device 300 may be used in association with both a personal and business account as discussed in this disclosure. The user interface page 402 may access the credit card application 312 and the functionality of user device 300 of FIG. 3 to act as a credit card.

FIGS. 5A-5B illustrate example user interface pages generated by credit card transaction reassignment application 105 for display on a user device 116 of FIG. 1, in accordance with the techniques of this disclosure. FIG. 5A shows user interface page 504 displayed on user device 300 for a credit card transaction showing transaction details 506 and a recommendation section 508 recommending that a transaction be applied to a virtual account such as a stash. In this example, the transaction details 506 show a $3,500 purchase was made at a computer store. Recommendation section 508 may enable the user to navigate to a user interface page such as user interface page 510 shown in FIG. 5B to adjust the source of the funds for a transaction. Recommendation information may be generated by computing system 208 using combined account management platform 204 and transferred to user device 300 for display. Computing system 208 may use data concerning the users accounts, transactions and other interactions to make the recommendations.

FIG. 5B shows user interface page 510 for a credit card transaction showing button 412 to take a photo or produce a scan of a receipt. Button 512 may launch a camera app or scanner app to take the photo or scan of the receipt. Receipt image display 514 may also be shown or linked to from user interface page 510. For example, the receipt image may be sent from user device 300 to computing system 208 and processed by credit card transaction reassignment application 105. The receipt images may then be stored associated with the page.

Functionality 516 may be used to assign or reassign payment of the purchase to different accounts or virtual accounts. In the example of FIG. 4C, $3000 is assigned to a computer stash and $500 assigned to savings. For example, user device 300 may send the reassignment messages to computing system 208 and computing system 208 may process the reassignment messages with combined personal and business account management platform 204. Drop-down menus 515 and 517 enable the page to receive user input to select a source of payment for the transaction. In this example, drop-down menu 515 has selected the computer stash for $3000 and drop-down menu 517 has selected savings for $500.

Messaging functionality 518 may be used to send messages to other users such as business partners. For example, user device 300 may send the messages to computing system 208 and combined account management platform 204 may process the messages and provide them to the appropriate users. Messaging functionality 518 enables for the reading and sending of messages.

FIGS. 6A-6C illustrate example user interfaces generated by a forecasting application 103 for display on a user device 116 of FIG. 1, in accordance with the techniques of this disclosure. For example, the forecast application 103 of combined account management platform 104 at computing system 102 may create and provide the forecasting information for display at user device 300.

FIG. 6A shows a user interface page 602 including a projection of cashflow for multiple days in section 604 and indications of predicted transactions in section 606. The user may click on projected transactions and update them as needed. FIG. 6B shows user interface page 608 including a calendar heatmap section 610 and an upcoming bills projection section 612. Calendar heatmap section 610 may show shapes, such as circles, associated with days of the calendar that may correspond to a specific predicted event. The color or shading of the circles may indicate whether the event is a credit or debit event and the size of the circles may indicate the size of the predicted events. For example, green may represent predicted incoming funds and red may represent predicted outgoing funds.

FIG. 6C shows user interface page 620 with a number of selectable options to fix an anticipated shortfall. Buttons 622, 624, 624, 526, 628 and 630 may act as links to additional user interface pages to handle a projected shortfall. Button 622 may be used to move money from another account for a projected shortfall. Button 624 may be used to modify a future bill pay such as by pushing a payment date back. Button 626 may be used to apply for a short term loan. Button 628 may be used to access a line of credit. Button 630 may be used to access reward points from a credit card.

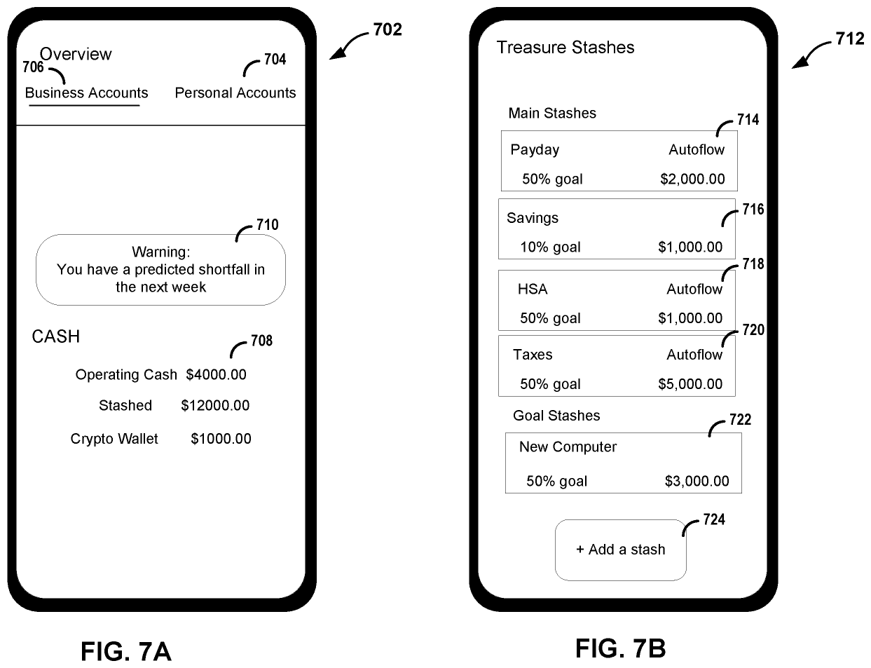

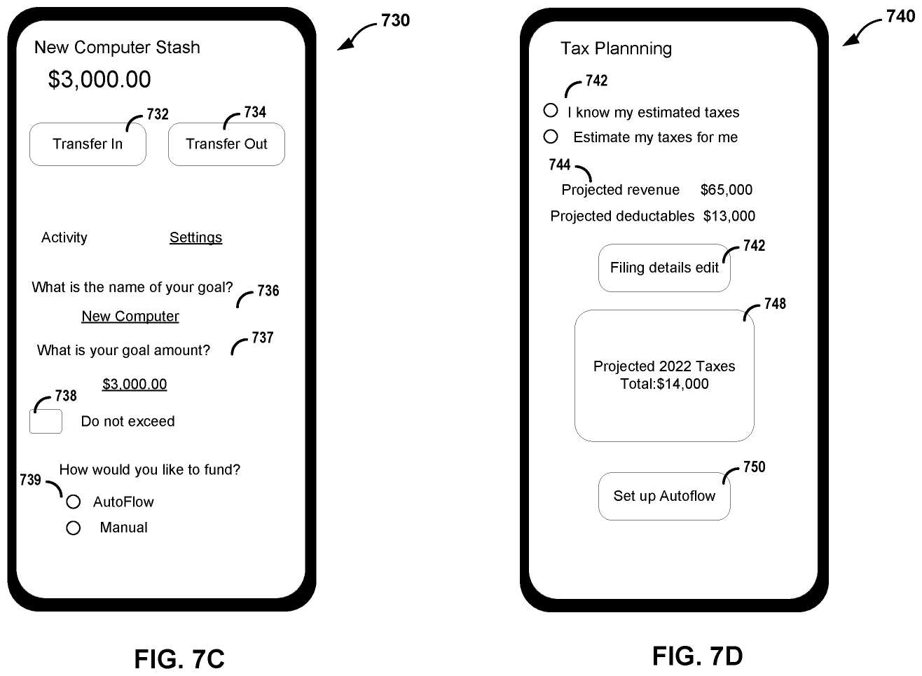

FIGS. 7A-7D illustrate example user interface pages generated by virtual account management application 101 for display on a user device 116 of FIG. 1, in accordance with the techniques of this disclosure. Virtual account management application 101 at computing system 102 may determine and provide the account information for display at the user device 116.

FIG. 7A shows an overview user interface page 702 including tab 704 for personal accounts and tab 706 for business accounts. In this example, tab 706 is selected and section 708 shows details of the business accounts. Warning 710 is also shown to warn of a predicted shortfall such as that described in FIGS. 7A-C.

FIG. 7B shows an overview user interface page 712 that shows virtual accounts such as stashes. In this example, payday stash section 714 shows payday stash details indicating autoflow for the stash and percentage of goal reached. Other stashes include savings stash section 716, health savings account (HAS) stash section 718, taxes stash 720, and new computer stash 722. Button 724 is used to select and open a new stash.

FIG. 7C shows a details page 730 to set up a new stash for an example stash. Button 732 is used to transfer money into the stash. Button 734 is used to transfer money out of the stash. Field 736 enables the stash to be named. Field 737 enables for a goal target to be input. Check box 738 indicates whether the goal target is enabled to be exceeded or is a ceiling for the stash. Toggle section 739 enables for fund source of the stash to be toggled between autoflow and manual.

FIG. 7D shows a details page 740 for a tax planning page that enables a user to estimate taxes and set up an appropriate tax stash. Input tax information may be provided to computing system 208 to calculate the correct tax rates. Toggle section 742 enables for toggling between manual or estimated taxes. Tax details section 744 indicates a summary of projected revenue and taxes. Button 746 selects tax filing details for editing. Window 748 shows projected taxes. Button 750 enables for the setting up of autoflow. Computing system 208 may then automatically provide deposited money into a tax stash.

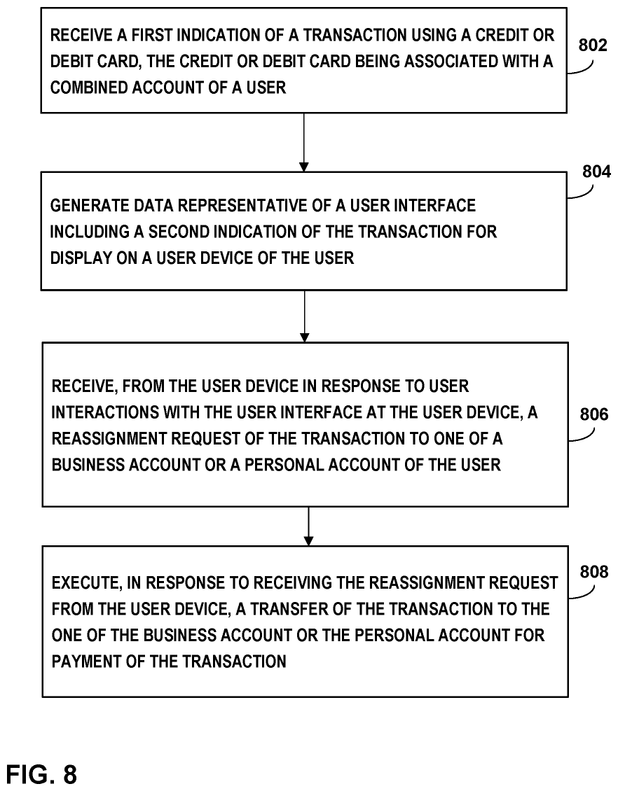

FIG. 8 is a flow diagram illustrating operations performed by an example computing device executing a credit card transaction reassignment application 105, in accordance with one or more aspects of the present disclosure. The operations of FIG. 8 are described within the context of computing system 102 and credit card transaction reassignment application 105 from FIG. 1. In other examples, operations described in FIG. 8 may be performed by computing system 208, credit card transaction reassignment application 205 of FIG. 2, or one or more other components, modules, systems, or devices. Further, in other examples, operations described in connection with FIG. 8 may be merged, performed in a difference sequence, or omitted.

Computing system 102 may receive a first indication of a transaction using a credit or debit card, the credit or debit card being associated with a combined account of a user (802). Computing system 102 may generate data representative of a user interface including a second indication of the transaction for display on a user device of the user (804). Computing system 102 may receive from the user device in response to user interactions with the user interface at the user device, a reassignment request of the transaction to one of a business account or a personal account of the user (806). Computing system 102 may execute, in response to receiving the reassignment request from the user device, a transfer of the transaction to the one of the business account or the personal account for payment of the transaction (808).

The personal account and the business account may be virtual accounts of a single underlying account. Computing system 102 may do a funds transfer as a result of the assignment of funds between the personal account and the business account of the single underlying account.

Combined account management platform 104 may enable business partners to share, annotate, and comment on transactions assigned to a shared business account. The business account may be shared with a second user, and computing system 102 may receive and transmit messages to and from the first user interface of the first user device, such as user device 116A, and a second user interface of a second user device, such as user device 116B, of the second user. The user devices may display messages on the first and second user interfaces along with details of the transaction. For example, consider a small two person partnerships where one person handles the finances and another person handles the business operations, such as a small auto detailing business. This messaging functionality enables them to communicate concerning expenses of the small business.

Computing system 102 may receive a receipt image associated with the transaction from the first user interface of the first device of the first user. Computing system 102 may transmit the receipt image to the second device of the second user for display at the second user interface along with the details of the transaction. Computing system 102 may manage permissions at the computing system to enable the second user using the second user interface on the second device access to the business account but block access to the personal account.

Computing system 102 may execute in response to receiving a reassignment request, a funds transfer between the business account and the personal account includes an interbank transfer of money. The credit or debit card may be stored on a virtual wallet application at a user device.

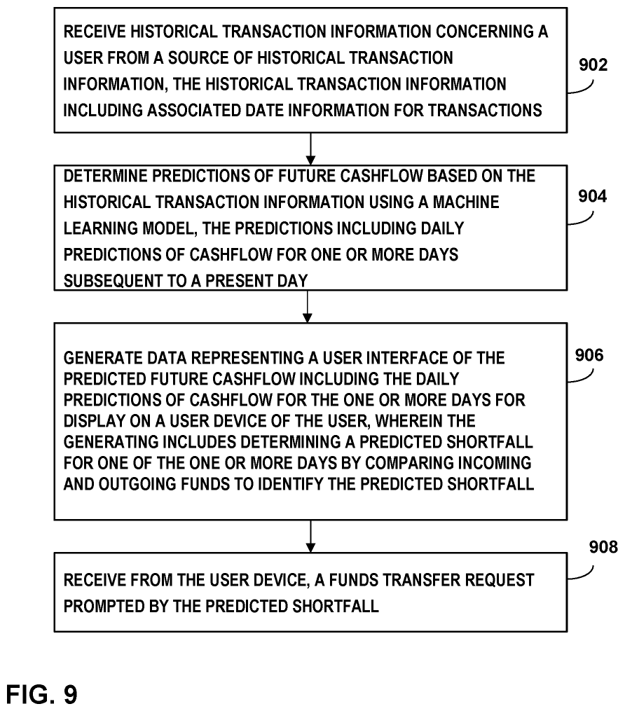

FIG. 9 is a flow diagram illustrating operations performed by an example computing device executing a forecasting application 103, in accordance with one or more aspects of the present disclosure. The operations of FIG. 9 are described within the context of computing system 102 and forecasting application 103 from FIG. 1. In other examples, operations described in FIG. 9 may be performed by computing system 208, forecasting application 203 of FIG. 2, or one or more other components, modules, systems, or devices. Further, in other examples, operations described in connection with FIG. 9 may be merged, performed in a difference sequence, or omitted. Computing system 102 may receive historical transaction information concerning a user from a source of historical transaction information, the historical transaction information including associated date information for transactions (902). Computing system 102 may determine predictions of future cashflow based on the historical transaction information using a machine learning model, the predictions including daily predictions of cashflow for one or more days subsequent to a present day (904). Computing system 102 may generate data representing a user interface of the predicted future cashflow including the daily predictions of cashflow for the one or more days for display on a user device of the user, wherein the generating includes determining a predicted shortfall for one of the one or more days by comparing incoming and outgoing funds to identify the predicted shortfall (906). Computing system 102 may receive, from the user device, a funds transfer request prompted by the predicted shortfall (908).

Computing system 102 may produce a recommendation of a fund source for a predicted shortfall. The fund source for a predicted shortfall may be a virtual account such as a stash. After a withdrawal from a virtual account, computing system 102 may send to the user device, such as one of the user devices 116, a recommendation to replenish the virtual account.

The virtual account may be associated with a potential purchase. The fund source for a predicted underflow may be a loan.

The predicted cashflow display may be a calendar and or a heat map. A heat map may show projected inflows and outflows as graphical elements. A calendar heat map may visually show flows of funds. The user interface may then be used by a user to see a potential shortfall and respond. Computing system 102 may the user to move funds around from different stashes and accounts to cover the shortfall. Computing system 102 may keep track of such fund transfers and enable accounts to be paid back for loans. Alternately, loans, lines of credits, or rewards points may be accessed.

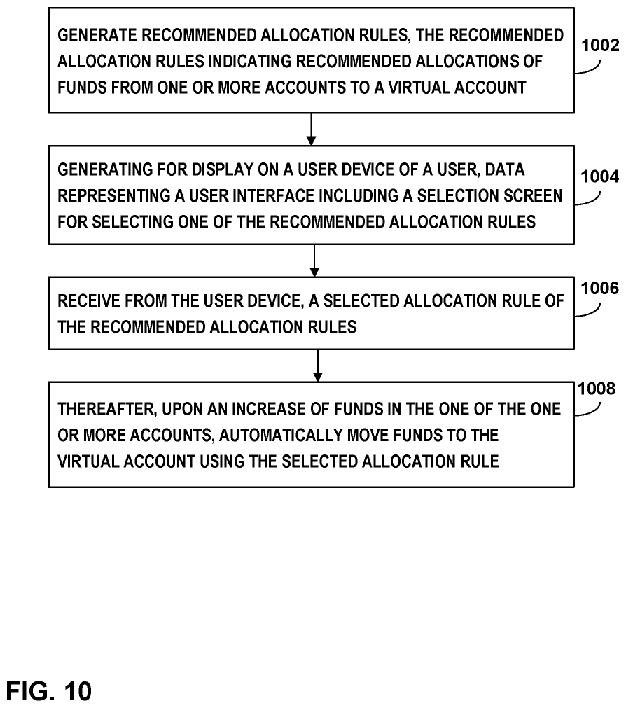

FIG. 10 is a flow diagram illustrating operations performed by an example computing device executing virtual account management application 101, in accordance with one or more aspects of the present disclosure. The operations of FIG. 10 are described within the context of computing system 102 and virtual account management application 101 from FIG. 1. In other examples, operations described in FIG. 10 may be performed by computing system 208, virtual account management application 201 of FIG. 2, or one or more other components, modules, systems, or devices. Further, in other examples, operations described in connection with FIG. 10 may be merged, performed in a difference sequence, or omitted.

Computing system 102 may generate recommended allocation rules, the recommended allocation rules indicating recommended allocations of funds from one or more accounts to a virtual account (1002). Computing system 102 may generate for display on a user device of a user data representing a user interface including a selection screen for selecting one of the recommended allocation rules (1004). Computing system 102 may receive, from the user device, a selected allocation rule of the recommended allocation rules (1006). Computing system 102 may thereafter, upon an increase of funds in the one of the one or more accounts, automatically moving funds to the virtual account using the selected allocation rule (1008). Computing system 102 may receive an indication to spend an amount from the virtual account. Computing system 102 may send an indication to at least one of the one or more sources of account information to modify the account information. Computing system 102 may transfer the amount.

Computing system 102 may associate some of funds indicated by the account information with a virtual account of funds may further be response to receiving from a user device a message to automatically associate funds with the virtual account periodically. Computing system 102 may produce and send a recommendation the user device to transfer funds into the virtual account.

The virtual account may be associated with taxes and the recommendation concerns a tax payment estimate. Computing system 102 may calculate an estimated tax rate based on user input and/or flows into the system. For example, if the calculated marginal rate is 28% then computing system 102 may divert 28% of inflows of funds into the tax stash automatically. Computing system 102 may determine a calculated tax rate or marginal tax rate using income and deduction information from a user.

Computing system 102 may have access and understanding of accounts, stashes and transactions so is able to make relevant offers and advice to users based on their context. Rich transaction and account information provide that holistic view of the user, whether it be personal or business, which may enable an institution comfort in providing loans or other liquidity.

The computing system 102 may produce and send a recommendation to a user device to transfer funds from the virtual account. The virtual account may be associated with a potential purchase and the recommendation may concerns the potential purchase. The recommendation may be associated with a discount offer from a supplier. Computing system 102 may also produce a recommendation to the user device to create the virtual account.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of computer program from one place to another, e.g., according to a communication protocol. In this manner, computer-readable storage media generally may correspond to (1) tangible computer-readable storage media which is non-transitory or (2) a communication media such as signal or carrier wave. Data storage media may be any available media that can be accessed by one or more computers or one or more processing circuits to receive instructs, code and/or data structures for implementation of the techniques described in this disclosure. A computer program product may include a computer-readable medium.

By way of example and not limitation, such computer-readable storage media may include RAM, ROM, EEPROM, CD-ROM, or other optical disk storage, magnetic disk storage, or other magnetic storage devices, flash memory, cache memory, or any other medium that can be used to store desired program code in the form of instructions or store data structures and that can be access by a computer. Also, any connection is a properly termed a computer-readable medium. For example, if instructions are transmitted from a website, server, or other remote source using a coaxial cable, fiber optic cable, twisted pair, digital subscriber line (DSL), or other wireless technologies such as infrared, radio, and microwave, then the coaxial cable, fiber optic cable, twisted pair, DSL, or other wireless technologies such as infrared, radio, and microwave are included in the definition of medium. It should be understood, however, that computer-readable storage media and data storage media do not include connections, carrier waves, signals, or other transient media, but are directed to non-transient, tangible storage media. Disk and disc, as used herein, includes compact disk (CD), laser disc, optical disc, digital versatile disc (DVD), and Blu-ray disc, where disks usually reproduce data magnetically, while discs reproduce data optically with lasers. Combinations of the above should be included within the scope of computer-readable media.

Functionality described in this disclosure may be performed by fixed function and/or programmable processing circuitry. For instance, instructions may be executed by fixed function and/or programmable processing circuitry. Such processing circuitry may include one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the term “processor”, as used herein may refer to any of the foregoing structure of any other structure suitable for implementation of the techniques described herein. In addition, in some aspects, the functionality described herein may be provided within dedicated hardware and/or software modules. Also, the techniques could be fully implemented in one or more circuits or logic elements. Processing circuits may be coupled to other components in various ways. For example, a processing circuit may be coupled to other components via an internal device interconnect, a wired or wireless network connection, or another communication medium.

The techniques of this disclosure may be implemented in a wide variety of devices or apparatuses, an integrated circuit (IC) or a set of ICs (e.g., a chip set). Various components, modules, software systems, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

1. A method comprising:
generating, by a computing system of an organization, recommended allocation rules, the recommended allocation rules indicating recommended allocations of funds from one or more accounts to a virtual account, wherein the one or more accounts include at least one internal account associated with the organization and at least one external account associated with a different organization;
generating, by the computing system for display on a user device of a user, data representing a user interface including a selection screen for selecting one of the recommended allocation rules;
receiving, by the computing system from the user device, a selected allocation rule of the recommended allocation rules; and
thereafter, upon an increase of funds in at least one of the one or more accounts, automatically moving funds to the virtual account using the selected allocation rule, wherein automatically moving the funds from the at least one external account includes instructing one or more other computing systems to transfer the funds via an interbank transfer.

2. The method of claim 1 wherein the virtual account is associated with taxes and the at least one of the recommended allocation rules is generated by the computing system using a tax payment estimate.

3. The method of claim 1, wherein the virtual account is associated with a potential purchase, wherein the method further comprises producing and sending a recommendation, to the user device, to transfer funds from the virtual account for a transaction related to the potential purchase.

4. The method of claim 1, further comprising:
receiving, by the computing system, an indication of a transaction on a credit or debit card associated with a first account;
sending, from the computing system to the user device, a transfer recommendation to transfer the transaction to the virtual account; and
in response to receiving a reassignment request from the user device, transferring the transaction to the virtual account.

5. The method of claim 4, further comprising determining the transfer recommendation based on details of the transaction including a store name.

6. The method of claim 1, wherein the virtual account is associated with a potential purchase, the method further comprising sending, to the user device, a discount offer from a supplier when an amount in the virtual account reaches a certain threshold.

7. The method of claim 1, further comprising:
producing, by the computing system, a virtual account creation recommendation based on historical transaction data to create the virtual account;
providing, by the computing system to the user device, the virtual account creation recommendation; and
creating, by the computing system in response to instructions from the user device, the virtual account.

8. The method of claim 1, further comprising:
receiving, at the computing system from the user device, a borrow request to borrow from the virtual account;
reallocating funds from the virtual account based on the borrow request; and
thereafter, automatically refilling the virtual account.

9. The method of claim 1, wherein the virtual account is associated with a goal and once the goal is reached, funds are no longer automatically transferred into the virtual account.

10. A computing system comprising:
one or more interfaces; and
one or more processors in communication with the one or more interfaces, the one or more processors configured to:
generate recommended allocation rules, the recommended allocation rules indicating recommended allocations of funds from one or more accounts to a virtual account, wherein the one or more accounts include at least one internal account associated with an organization of the computing system and at least one external account associated with a different organization;
generate, for display on a user device of a user, data representing a user interface including a selection screen for selecting one of the recommended allocation rules;
receive, from the user device, a selected allocation rule of the recommended allocation rules; and
thereafter, upon an increase of funds in at least one of the one or more accounts, automatically move funds to the virtual account using the selected allocation rule, wherein automatically moving the funds from the at least one external account includes instructing one or more other computing systems to transfer the funds via an interbank transfer.

11. The computing system of claim 10, wherein the virtual account is associated with taxes and the at least one of the recommended allocation rules is generated by the computing system using a tax payment estimate.

12. The computing system of claim 10, wherein the virtual account is associated with a potential purchase and wherein the one or more processors are further configured to produce and send a recommendation to the user device to transfer funds from the virtual account for a transaction related to the potential purchase.

13. The computing system of claim 10, wherein the one or more processors are further configured to:
receive an indication of a transaction on a credit or debit card associated with a first account;
send to the user device a transfer recommendation to transfer the transaction to the virtual account;
in response to receiving a reassignment request from the user device, transfer the transaction to the virtual account.

14. The computing system of claim 13, wherein the transfer recommendation is produced based on details of the transaction including a store name.

15. The computing system of claim 10, wherein the virtual account is associated with a potential purchase further wherein the one or more processors are further configured to send a discount offer from a supplier when an amount in the virtual account reaches a certain threshold.

16. The computing system of claim 10, wherein the one or more processors are further configured to:
produce a virtual account creation recommendation based on historical transaction data to create the virtual account;
provide to the user device the virtual account creation recommendation,
create, in response to instructions from the user device, the virtual account.

17. The computing system of claim 10, wherein the one or more processors are further configured to:
receive, from the user device, a borrow request to borrow from the virtual account;
reallocate funds from the virtual account based on the borrow request; and
thereafter, automatically refill the virtual account.

18. The computing system of claim 10, wherein the virtual account is associated with a goal and once the goal is reached, funds are no longer automatically transferred into the virtual account.

19. A non-transitory computer-readable storage medium comprising instructions that, when executed, cause one or more processors to:
generate recommended allocation rules, the recommended allocation rules indicating recommended allocations of funds from one or more accounts to a virtual account, wherein the one or more accounts include at least one internal account associated with an organization of the computing system and at least one external account associated with a different organization;
generate, for display on a user device of a user, data representing a user interface including a selection screen for selecting one of the recommended allocation rules;
receive, from the user device, a selected allocation rule of the recommended allocation rules; and
thereafter, upon an increase of funds in at least one of the one or more accounts, automatically move funds to the virtual account using the selected allocation rule, wherein automatically moving the funds from the at least one external account includes instructing one or more other computing systems to transfer the funds via an interbank transfer.

20. The computer-readable storage medium of claim 19, wherein the virtual account is associated with taxes and the at least one of the recommended allocation rules is generated by the computing system using a tax payment estimate.
